(19) United States
(12) Patent Application Publication
(10) Pub. No.: US 2007/0250283 A1
(43) Pub. Date: Oct. 25, 2007

(54) Maintenance and Calibration Operations for Memories

(76) Inventors: Melissa A. Barnum, Kasson, MN (US); Mark D. Bellows, Rochester, MN (US); Lonny Lambrecht, Byron, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/380,025

(22) Filed: Apr. 25, 2006

(51) Int. Cl. G06F 19/00

(52) U.S. Cl. 702/117; 702/85; 702/107; 702/108; 714/47; 714/718

(57) ABSTRACT

Embodiments of the present invention provide methods, systems and apparatus for performing memory maintenance and calibration operations. To perform calibration operations, calibration data may first be written to memory, and subsequently read back. The calibration operations may then be performed in response to detecting discrepancies between the data written and data read back from memory. To prevent the calibration data from being altered during memory maintenance operations, embodiments of the invention provide for the skipping of sections containing calibration data during the memory maintenance operations. Therefore, the calibration data is preserved, allowing for appropriate calibration operations to be performed.

### BACKGROUND OF THE INVENTION

1. Field of the Invention

The present invention generally relates to computer systems, and more specifically to performing memory maintenance and calibration operations.

2. Description of the Related Art

Most modern computer systems employ some type of random access memory, such as Dynamic Random Access Memory (DRAM). DRAM devices may be configured to provide high bandwidth, low latency memory data accesses. To increase system performance, the data transfer rates between DRAM and other system devices, for example, a memory controller, have been steadily increasing over the years.

Unfortunately, as the data transfer rate between devices increases, bytes of data transferred between devices may become skewed for different reasons, such as channel temperature variations, internal capacitance, differences in currents and voltages of drivers and/or receivers used on the different devices, different routing of internal bus paths, and the like. Such skew may cause data transferred from one device to be read erroneously by the other device. This misalignment can lead to incorrectly assembled data fed into the processor cores of the system, which may have unpredictable results and hamper performance.

To prevent data skewing, one or more calibration operations may be performed at regular intervals to ensure accurate transfer of communications between devices. The calibration operations may include current calibration, channel temperature calibration, and the like.

While most memory calibration operations do not alter memory, some calibration operations may require calibration data to be written to and subsequently read from sections of memory. For example, a predefined pattern of calibration data may be written to a section of memory. Subsequently, the section to which the calibration data was written may be read from memory to compare the retrieved data with the predefined pattern. By detecting inconsistencies in the calibration data written to and read from the memory, parameters such as channel temperature, currents, and voltages may be adjusted to ensure accurate data transfers.

The calibration operations described above may be continuously performed to ensure that data transfers occur within the data eye for memory transfers. The data eye may describe the bounds of various parameter settings within which accurate data transfers occur. Parameter settings outside the bounds of the data eye may cause erroneous data transfers. Therefore, the calibration operations may measure the data eye and implement settings wherein data transfers occur within the data eye.

One problem with performing such memory calibration operations is that some memory maintenance operations, for example, memory scrubbing and memory zeroing, may alter calibration data that is written to a section of memory. During memory scrubbing, for example, a memory controller may read memory during idle periods, correct single bit errors, and write the corrected contents back to memory. Memory zeroing, for example, may include replacing contents of particular sections or the entire memory with logic 0's. The altering of calibration data stored in memory may restrict the ability to properly calibrate the system.

Therefore, what is needed are improved methods, systems and apparatus for performing memory maintenance and calibration operations.

### SUMMARY OF THE INVENTION

The present invention generally relates to performing memory maintenance and memory calibration operations.

One embodiment of the invention provides a method for performing a memory maintenance operation. The method generally comprises sequentially selecting addresses of memory where the memory maintenace operation is to be performed, determining whether a selected address falls within an address range of memory containing calibration data, and in response to determining that the selected address falls within the address range of memory containing the calibration data, skipping to a next address without performing the memory maintenance operation at the selected address.

Another embodiment of the invention provides a controller configured to for perform a memory maintenance operation. The controller is generally configured to sequentially select addresses of memory to perform a memory maintenace operation, determine whether a selected address falls within an address range of memory containing calibration data, and in response to determining that the address falls within the address range of memory containing the calibration data, skip to a next address without performing the memory maintenance operation at the selected address.

Yet another embodiment of the invention provides a device comprising memory, a calibration register containing an address range of the memory where calibration data is stored, and a controller. The controller is generally configured to sequentially select addresses of the memory to perform a memory maintenace operation, determine whether a selected address falls within the address range in the memory comprising calibration data, and in response to determining that the address falls within the address range in the memory comprising the calibration data, skip to a next address without performing the memory maintenance operation at the selected address.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an illustration of an exemplary system according to an embodiment of the invention.

FIG. 2 is an illustration of the exchange of calibration data between a memory controller and memory, according to an embodiment of the invention.

FIG. 3 is an illustration of an exemplary calibration register according to an embodiment of the invention.

FIG. 4 is a flow diagram of exemplary steps to perform memory maintenance operations, according to an embodiment of the invention.

### DETAILED DESCRIPTION OF THE PREFERRED EMBODIMENTS

Embodiments of the present invention provide methods, systems and apparatus for performing memory maintenance and calibration operations. To perform calibration operations, calibration data may first be written to memory, and subsequently read back. The calibration operations may then be performed in response to detecting discrepancies between the data written and data read back from memory. To prevent the calibration data from being altered during memory maintenance operations, embodiments of the invention provide for the skipping of sections containing calibration data during the memory maintenance operations. Therefore, the calibration data is preserved, allowing for appropriate calibration operations to be performed.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Exemplary System

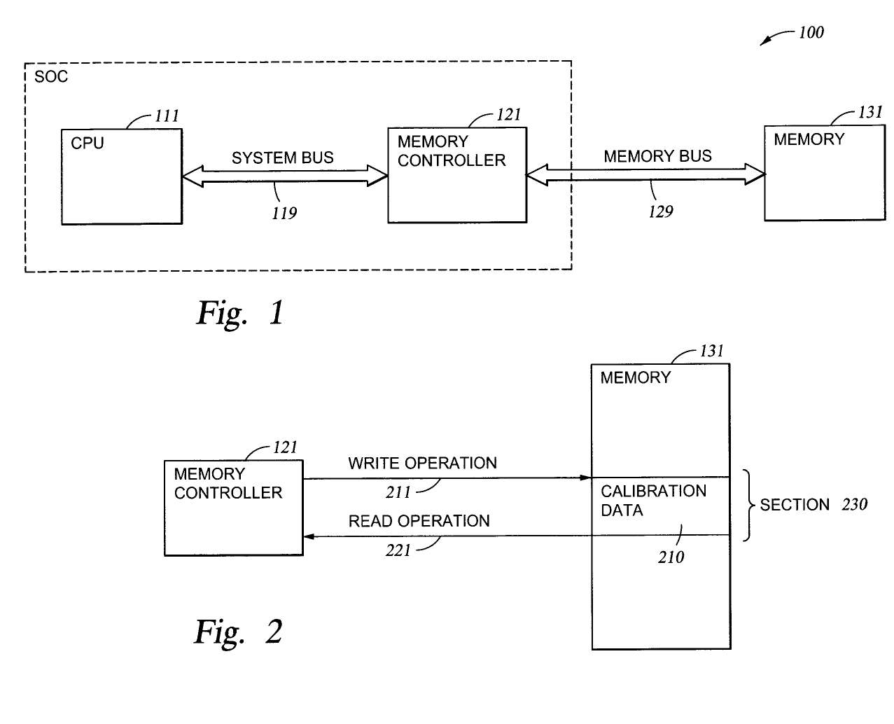

FIG. 1 illustrates a block diagram of an exemplary system 100 in which embodiments of the invention may be implemented. System 100 includes a Central Processing Unit (CPU) 111, Memory Controller 121, and Memory 131. CPU 111 may be coupled to Memory Controller 121 via a system bus 119. In some embodiments, CPU 111 and Memory Controller 121 may be integrated into a system on a chip (SOC), as illustrated in FIG. 1.

CPU 111 may be configured to issue commands to Memory Controller 121. For example, CPU 111 may issue read and write commands to Memory Controller 121 to perform read or write accesses to Memory 131. One skilled in the art will recognize that while one CPU 111 is shown, a plurality of CPUs 111 may be coupled to bus 119. Furthermore, each CPU 111 may be configured to issue its own respective commands to Memory Controller 121.

Memory 131 may be a random access memory, such as a Dynamic Random Access Memory (DRAM). Memory 131 may be sufficiently large to hold one or more programs and/or data structures being processed by CPU 111. While the memory 131 is shown as a single entity, it should be understood that the memory 131 may in fact comprise a plurality of modules, and that the memory 131 may exist at multiple levels from high speed caches to lower speed but larger DRAM chips.

Memory Controller 121 may be communicably coupled to Memory 131 via memory bus 129. Memory Controller 121 may be configured to perform accesses to memory 131 in response to receiving commands from CPU 111. For example, CPU 111 may issue a read command containing an address of memory 131 identifying the location of desired data. In response to receiving the read command, Memory Controller 131 may access Memory 131 to retrieve the desired data from the specified address in Memory 131. The retrieved data may then be provided to CPU 111 over system bus 119. One skilled in the art will recognize that while shown separately in FIG. 1, Memory Controller 121 may be a part of CPU 111. Therefore, memory accesses may be performed by Memory Controller 121 over a bus coupling the CPU to Memory 131.

Memory Calibration and Maintenance Operations

Memory Controller 121 may be further configured to perform memory calibration operations to ensure accurate data transfers with Memory 131. Memory calibration operations, for example, may be performed to calibrate channel temperature, driver currents, refresh operations, and the like. The calibration may reduce data skewing, thereby reducing the occurrence of erroneous data transfers between devices and improving performance.

In some embodiments, calibration of channel temperature, driver currents, and the like may occur in response to determining erroneous data transfers between devices. For example, Memory controller 121 may write a predetermined pattern of data to a given section of Memory 131. Subsequently, Memory Controller 121 may read back the given section of Memory 131. Memory Controller 121 may compare the data retrieved from the given section with the predetermined pattern to detect errors. In response to detecting errors, Memory Controller 121 may perform memory maintenance operations such as channel temperature calibration, driver current calibration, and the like, based on the detected errors.

In other embodiments, calibration operations may occur after any power down exit. In such embodiments, the calibration data may be written to Memory 131 at the time of the power down exit. At the next system initialization, operating system code, for example Basic Input/Output System (BIOS) code may cause the memory controller to read the calibration data, and a compare the calibration data with the predetermined pattern made to determine the specific calibration operations that may be necessary for accurate data transfers between devices.

FIG. 2 illustrates a section 230 of Memory 131 to which Memory Controller 121 may write calibration data 210. Calibration data 210, for example, may include any predetermined pattern of logic 0's and logic 1's. In some embodiments, because Calibration data 210 is used only for calibration purposes the calibration data may have poor Error Correction Code (ECC). ECC, for example, Hamming Code, Reed-Solomon Code, etc. may be configured to correct single bit, double bit, or even multiple bit errors.

As illustrated in FIG. 2, Calibration data 210 may be written by Memory Controller 121 to section 230 by performing a write operation 211, for example, over memory bus 129. Subsequently, Memory Controller 121 may perform a read operation 221 at section 230 to retrieve the calibration data 210 stored during the previous write operation 211.

Discrepancies between the calibration data written to section 230 and the calibration data retrieved during the read operation may indicate the need to perform one or more calibration operations. Because the calibration data has a predetermined pattern, the Memory Controller 121 may identify particular devices, channels, etc. requiring calibration based on the discrepancies between the pattern written and the pattern that is read back from Memory 131. Accordingly, Memory Controller 121 may perform one or more calibration operations on the devices/channels. For example, Memory controller 121 may identify a particular driver responsible for writing a portion of the calibration data containing the discrepancy. Memory Controller 121 may adjust the driver current for the driver to correct the discrepancy.

In addition to the calibration operations, Memory Controller 121 may also periodically perform one or more memory maintenance operations that alter the contents of memory. Illustrative memory maintenance operations include memory scrubbing and memory zeroing.

Memory scrubbing is a process in which Memory Controller 121 may read blocks of memory 131 during idle periods, correct single bit errors, and write back the contents to memory to prevent single bit errors from adding up into non-correctable multi-bit errors. Memory scrubbing may be performed by Memory Controller 121 in the background during normal operation of the system by sweeping through the entire contents of Memory 131. ECC associated with the contents of Memory 131 may be used to identify and correct errors.

Memory zeroing, on the other hand, may involve replacing one or more sections or all of the contents of Memory 131 with logic 0's. Zeroing may be performed, for example, to remove sensitive data in Memory 131 after it is no longer required. By replacing the sensitive data by logic 0's inadvertent, unauthorized access of the sensitive data may be prevented. Memory zeroing may be performed at system initialization and/or periodically during normal operation of the system. As with memory scrubbing, zeroing may involve sweeping through all of Memory 131 or a particular section of Memory 131 to replace the contents of Memory 131 with logic 0's.

Preserving Calibration Data

Memory maintenance operations including, but not limited to, memory scrubbing and memory zeroing may alter sections of Memory 131 containing calibration data, for example, section 230 illustrated in FIG. 2. However, altering the calibration data is not desirable because the calibration data may contain the information necessary to perform calibration operations. To prevent memory maintenance operations from altering calibration data, embodiments of the invention allow skipping of sections in Memory 131 that contain calibration data.

In one embodiment, a calibration register containing the starting and ending address of the calibration data may be provided. The operating system may be configured to cause Memory controller 121 to access the calibration register at system start-up and periodically to identify the location of calibration data. Memory Controller 121 may skip the address range provided in the register while performing the memory maintenance operations.

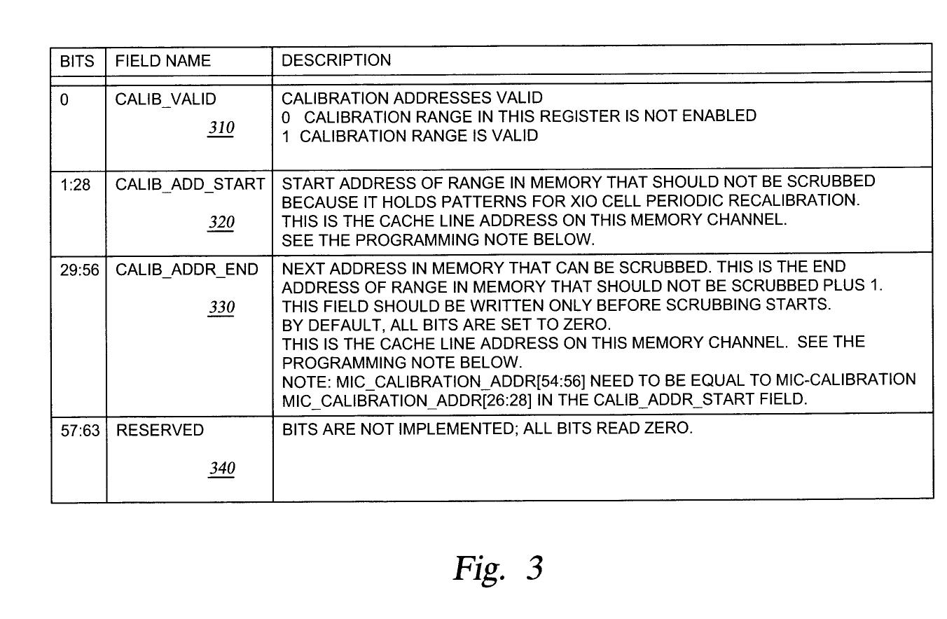

FIG. 3 illustrates an exemplary 64-bit Calibration Register 300, according to an embodiment of the invention. As illustrated, Calibration Register 300 may include a Calibration Valid field 310, Calibration Start Address field 320. Calibration End Address field 330, and Reserved field 340.

As illustrated, Calibration Valid field 310 may be a single bit indicating whether the address range specified in the register contains calibration data. For example, in the exemplary illustration in FIG. 3, a Calibration Valid bit 310 set to logic 0 indicates that the register is not enabled. Therefore, the address range specified in the register may not contain calibration data. Therefore, the address range specified in the register may not be skipped during memory maintenance operations.

On the other hand, a Calibration Valid bit 310 set to logic 1 indicates that calibration data is present in the address range. Therefore, the memory range specified in the register may be skipped during memory maintenance operations. One skilled in the art will recognize that embodiments of the invention are not limited to the particular implementation of the Calibration Valid bit described above. For example, the logic values indicating whether Register 300 is enabled may be reversed. Furthermore, any other reasonable means for indicating whether Register 300 is disabled, for example, writing a predefined value to Register 300, may also be implemented.

As illustrated in FIG. 3, Calibration Start Address 320 and Calibration End Address 330 may be 28 bit address fields indicating the beginning address and ending address of a section of memory containing calibration data. For example, Calibration Start Address 320 may indicate the beginning address of section 230 in FIG. 2. Therefore, contents beginning at the Calibration start address may not be scrubbed.

Calibration End Address 330 may indicate a next address, following section 230, where the memory maintenance operation may be performed. For example, Calibration End Address may be the next address following the ending address of section 230. While the beginning and ending address fields are 28 bits in the exemplary register 300, one skilled in the art will recognize that any number of bits may be used for the address fields. The number of bits, for example, may depend on the size of the memory being addressed.

Reserved Field 340 may contain one or more bits reserved for later use. For example, Reserved Field 340 may indicate the types of memory maintenance operations for which the address range specified by Calibration Start Address 320 and Calibration End Address 330 must be skipped.

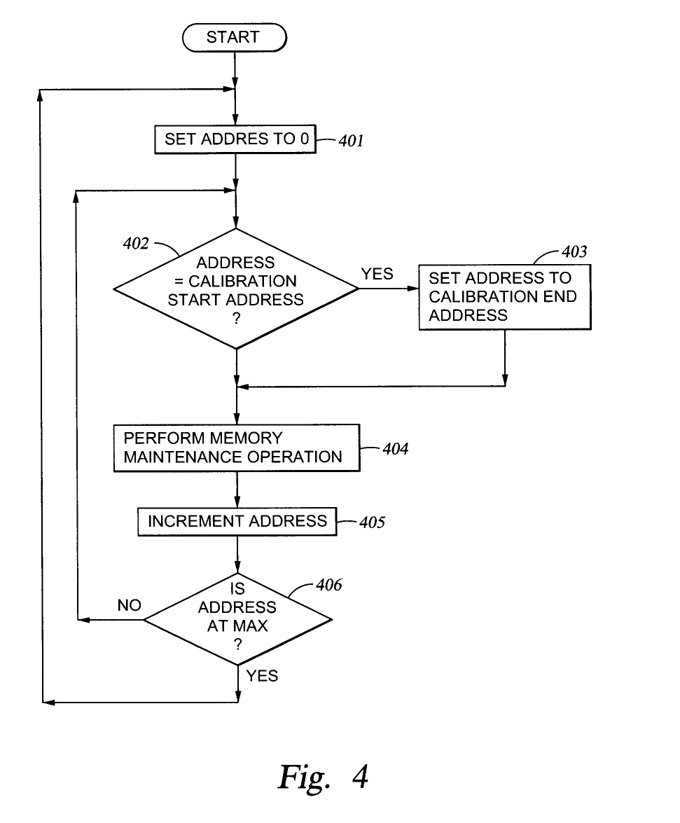

FIG. 4 illustrates a flow diagram of exemplary operations performed by a memory controller, when the calibration register is enabled, to perform memory maintenance operations that alter the contents of memory, for example, a memory scrub or memory zeroing. The operations begin in step 401 by setting the address for memory access to zero, thereby beginning the memory maintenance operation at the top of the memory. In step 402, the memory controller may determine whether the address is equal to the calibration start address by accessing the calibration register (for example, Calibration Register 300).

If the address points to the calibration start address, the address may be set to the calibration end address, in step 403. One skilled in the art will recognize that the setting of the address to the calibration end address may be configured to access contents of memory immediately following the end of the segment containing calibration data. Accordingly, in step 404, the memory maintenance operation may be performed on the contents immediately following the end of the segment containing calibration data. One skilled in the art will recognize that if the calibration register is not enabled, for example, by a setting of the calibration valid bit, resetting of the calibration address may not be performed.

If, in step 402, it is determined that the address does not point to the calibration address, or if the calibration register is not enabled, the memory maintenance operation may be performed at the address in step 404. After a memory maintenance operation is performed, the address may be incremented to point to the next block of memory in step 405.

After the memory maintenance operations are performed at all locations, except locations where there may be calibration data, the address may be set back to 0 for a next cycle of memory maintenance operations. Therefore, in step 406 the incremented address may be checked to determine whether the current cycle of memory maintenance operations has completed. If the address is the maximum address addressable in memory, in Step 406, the address may be set back to zero in step 401. If, on the other hand, the address is not a maximum address, the address may be compared to the calibration start address in step 402.

Conclusion

By allowing sections of memory containing calibration data to be skipped during memory maintenance operations, embodiments of the invention allow for proper calibration of the system, thereby increasing reliability of data transfers and performance of the system.

While the foregoing is directed to embodiments of the present invention, other and further embodiments of the invention may be devised without departing from the basic scope thereof, and the scope thereof is determined by the claims that follow.

What is claimed is:

1. A method for performing a memory maintenance operation, comprising:
sequentially selecting addresses of memory where the memory maintenace operation is to be performed;
determining whether a selected address falls within an address range of memory containing calibration data; and
in response to determining that the selected address falls within the address range of memory containing the calibration data, skipping to a next address without performing the memory maintenance operation at the selected address.

2. The method of claim 1, wherein the next address addresses contents of memory immediately following the address range of memory containing the calibration data.

3. The method of claim 1, wherein determining whether the selected address falls within the address range of memory containing the calibration data comprises accessing a calibration register, the calibration register containing the address range for the calibration data.

4. The method of claim 3, further comprising determining whether the calibration register is enabled, the enablement of the calibration register indicating that the address range for the calibration data contains the calibration data.

5. The method of claim 4, comprising skipping to the next address in response to determining that the calibration register is enabled.

6. The method of claim 4, wherein determining whether the calibration register is enabled comprises examining a valid bit contained in the calibration register, the valid bit indicating whether the calibration register is enabled.

7. The method of claim 1, wherein the memory maintenance operation comprises one of memory scrubbing or memory zeroing.

8. A controller configured to:
sequentially select addresses of memory to perform a memory maintenace operation;
determine whether a selected address falls within an address range of memory containing calibration data; and
in response to determining that the address falls within the address range of memory containing the calibration data, skip to a next address without performing the memory maintenance operation at the selected address.

9. The controller of claim 8, wherein the next address addresses contents of memory immediately following the address range of memory containing the calibration data.

10. The controller of claim 8, wherein the memory controller is configured to determine whether the selected address falls within the address range of memory containing the calibration data by accessing a calibration register, the calibration register containing the address range for the calibration data.

11. The controller of claim 10, wherein the memory controller is further configured to determine whether the calibration register is enabled, the enablement of the calibration register indicating that the address range for the calibration data contains calibration data.

12. The controller of claim 11, wherein the memory controller is configured to skip to the next address in response to determining that the calibration register is enabled.

13. The controller of claim 11, wherein the memory controller is configured to determine whether the calibration register is enabled by examining a valid bit contained in the calibration register, the valid bit indicating whether the calibration register is enabled.

14. The controller of claim 8, wherein the memory maintenance operation comprises one of memory scrubbing or memory zeroing.

15. A device, comprising:
memory;
a calibration register containing an address range of the memory where calibration data is stored; and
a controller configured to:
sequentially select addresses of the memory to perform a memory maintenace operation;
determine whether a selected address falls within the address range in the memory comprising calibration data; and
in response to determining that the address falls within the address range in the memory comprising the calibration data, skip to a next address without performing the memory maintenance operation at the selected address.

16. The device of claim 15, wherein the next address addresses contents in the memory immediately following the address range in the memory containing the calibration data.

17. The device of claim 15, wherein the controller is further configured to determine whether the selected address falls within the address range in the memory comprising the calibration data by accessing the calibration register.

18. The device of claim 15, wherein the controller is further configured to determine whether the calibration register is enabled, the enablement of the calibration register indicating that the address range for the calibration data contains the calibration data.

19. The device of claim 15, wherein the controller is configured to skip to the next address in response to determining that the calibration register is enabled.

20. The device of claim 15, wherein the controller is configured to determine whether the calibration register is enabled by examining a valid bit contained in the calibration register, the valid bit indicating whether the calibration register is enabled.
